(19) United States
(12) Patent Application Publication
(10) Pub. No.: US 2019/0012335 A1
(43) Pub. Date: Jan. 10, 2019

(54) DATA SHARING SYSTEM, DATA SHARING METHOD, AND PROGRAM

(71) Applicant: OPTiM Corporation, Saga-shi (JP)

(72) Inventor: Shunji SUGAYA, Tokyo (JP)

(21) Appl. No.: 16/108,220

(22) Filed: Aug. 22, 2018

Related U.S. Application Data
(63) Continuation of application No. PCT/JP2016/055511, filed on Feb. 24, 2016.

(51) Int. Cl. G06F 17/30; H04L 29/08

(52) U.S. Cl. CPC G06F 17/30283; H04L 67/10

(57) ABSTRACT

A data sharing system of performing data sharing by transmitting data stored in a transmitting terminal 100 operated by a user to a counterpart terminal 200 operated by a counterpart user, accepts a request from the transmitting terminal 100, notifies the request to the counterpart terminal 200, requests to the transmitting terminal 100 an approval about whether to disclose information related to the request to the counterpart terminal, and transmits the information related to the request to the counterpart terminal to perform data sharing when the approval is made.

### CROSS-REFERENCE TO RELATED APPLICATION

This application is a continuation-in-part of PCT Application No. PCT/JP2016/055511 filed on Feb. 24, 2016, the entire contents of which are incorporated herein by reference.

### BACKGROUND

### (a) Field

The present invention relates to a data sharing system, a data sharing method, and a program for sharing data by transmitting data stored in a transmitting terminal operated by a user to a counterpart terminal operated by a counterpart user.

### (b) Description of the Related Art

In recent years, various services have been provided to users by connecting a plurality of information terminals connected to a public line network or the like via a web server or directly. In particular, with the widespread use of smartphones (high-function mobile phones), it has become possible to perform advanced services conventionally performed on personal computers with mobile phones.

As an example of such the advanced service, there is a service of executing data sharing between a transmitting terminal operated by a user and a counterpart terminal operated by a counterpart user, by communicatively connecting the transmitting terminal operated and the counterpart terminal to transmit data stored in the transmitting terminal to the counterpart terminal.

As such data sharing, for example, a data sharing system is disclosed in which the transmitting terminal can select information which is highly likely not possessed by the counterpart terminal and transmit the selected information to the counterpart terminal (See Japanese Patent Application Publication No. 2014-170293).

However, according to the configuration of Japanese Patent Application Publication No. 2014-170293, it is possible to transmit information which is highly likely not stored in the counterpart terminal, but there is the possibility of transmitting this information even in a case where the transmitting terminal does not desire to transmit this information. For this reason, the information which is not intended by the user is transmitted so that the user's convenience is low. As such, there is a technical problem in the existing technology related to the data sharing that the convenience of the data sharing system is low because the data sharing system cannot provide a technical solution for preventing information not intended by the user from being shared and for allowing information desired by the user to be shared.

### SUMMARY

An aspect of the present invention provides a data sharing system, a data sharing method, and a program, in which convenience of a user is improved by sharing information desired by a user in data sharing.

A first aspect of the present invention provides a data sharing system of performing data sharing by transmitting data stored in a transmitting terminal operated by a user to a counterpart terminal operated by a counterpart user. The data sharing system includes a request accepting unit that accepts a request from the transmitting terminal, a request notifying unit that notifies the request to the counterpart terminal, an approval unit that requests to the transmitting terminal an approval about whether to disclose information related to the request to the counterpart terminal, and an information sharing unit that transmits the information related to the request to the counterpart terminal to perform data sharing when the approval is made.

According to the first aspect of the present invention, a data sharing system of performing data sharing by transmitting data stored in a transmitting terminal operated by a user to a counterpart terminal operated by a counterpart user, accepts a request from the transmitting terminal, notifies the request to the counterpart terminal, requests to the transmitting terminal an approval about whether to disclose information related to the request to the counterpart terminal, and transmits the information related to the request to the counterpart terminal to perform data sharing when the approval is made.

Here, the invention according to the first aspect is a category of a data sharing system, but exhibits the same action and effect corresponding to the category even in other categories such as a data sharing method, a program, and the like.

A second aspect of the invention provides the data sharing system which is the invention according to the first aspect, wherein the approval unit allows the user to arbitrarily select information to be disclosed to the counterpart user from among a plurality of information related to the request, and wherein the information sharing unit transmits only the information selected by the approval unit to the counterpart terminal to perform the data sharing.

According to the second aspect of the invention, the data sharing system, which is the invention according to the first aspect, allows the user to arbitrarily select information to be disclosed to the counterpart user from among a plurality of information related to the request, and transmits only the information selected by the approval unit to the counterpart terminal to perform the data sharing.

A third aspect of the invention provides the data sharing system which is the invention according to the first aspect, wherein the information sharing unit transmits the data and performs the data sharing by arbitrarily customizing the information related to the request.

According to the third aspect of the invention, the data sharing system, which is the invention according to the first aspect, transmits the data and performs the data sharing by arbitrarily customizing the information related to the request.

According to a fourth aspect of the present invention provides the data sharing system, which is the invention according to the first aspect, further including a storing unit that stores data excluding the information related the request.

According to the fourth aspect of the invention, the data sharing system, which is the invention according to the first aspect, stores data excluding the information related the request.

A fifth aspect of the invention provides a data sharing method for performing data sharing by transmitting data stored in a transmitting terminal operated by a user to a counterpart terminal operated by a counterpart user. The data sharing method includes accepting a request from the transmitting terminal, notifying the request to the counterpart terminal, requesting to the transmitting terminal an approval about whether to disclose information related to the request to the counterpart terminal, and transmitting the information related to the request to the counterpart terminal to perform data sharing when the approval is made.

A sixth aspect of the present invention provides a program for causing a data sharing system of performing data sharing by transmitting data stored in a transmitting terminal operated by a user to a counterpart terminal operated by a counterpart user to execute accepting a request from the transmitting terminal, notifying the request to the counterpart terminal, requesting to the transmitting terminal an approval about whether to disclose information related to the request to the counterpart terminal, and transmitting the information related to the request to the counterpart terminal to perform data sharing when the approval is made.

A seventh aspect of the invention provides a data sharing system of performing data sharing by transmitting data stored in a transmitting terminal operated by a user to a counterpart terminal operated by a counterpart user. The data sharing system includes a request accepting unit that accepts a request including a keyword from the transmitting terminal, an analyzing unit that extracts a keyword within the request and specifies a counterpart terminal corresponding to the request in accordance with the keyword, a request notifying unit that notifies the request to the counterpart terminal, an approval unit that requests to the transmitting terminal an approval about whether to disclose information related to the request to the counterpart terminal, and an information sharing unit that transmits the information related to the request to the counterpart terminal to perform data sharing when the approval is made.

According to the seventh aspect of the present invention, because the information related to the request is transmitted to the counterpart terminal when the transmitting terminal approves to disclose the information related to the request to the counterpart terminal, information not intended by the user can be prevented from being shared and information desired by the user can be shared. Furthermore, because the counterpart terminal for the data sharing is specified in accordance with the keyword within request, the information can be shared with a first counterpart terminal but cannot be shared with a second counterpart terminal based on the keyword included in the request. In other words, the information can be prevented from being shared or can be shared based on the keyword included in the request. Accordingly, the seventh aspect of the present invention can provide a technical solution for preventing information not intended by the user from being shared and for allowing information desired by the user to be shared, thereby improving the convenience of the data sharing system.

According to an aspect of the present invention, a data sharing system, a data sharing method, and a program, in which convenience of a user is improved by sharing information desired by a user in data sharing, can be provided.

### BRIEF DESCRIPTION OF THE DRAWINGS

FIG. 1 is a diagram showing an overview of a data sharing system 1.

FIG. 2 is an overall configuration diagram of a data sharing system 1.

FIG. 3 is a functional block diagram of a transmitting terminal 100 and a counterpart terminal 200.

FIG. 4 is a flowchart showing a personal data registering process executed by a transmitting terminal 100.

FIG. 5 is a flowchart showing a request transmitting process executed by a transmitting terminal 100 and a counterpart terminal 200.

FIG. 6 is a flowchart showing an information disclosing process executed by a transmitting terminal 100 and a counterpart terminal 200.

FIG. 7 is a diagram showing a personal data table.

FIG. 8 is a diagram showing a personal data table.

FIG. 9 is a diagram showing an information disclosure content approval screen.

FIG. 10 is a diagram showing an information disclosure content approval screen.

FIG. 11 is a diagram showing shared data.

FIG. 12 is a diagram showing shared data.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

Overview of Data Sharing System 1

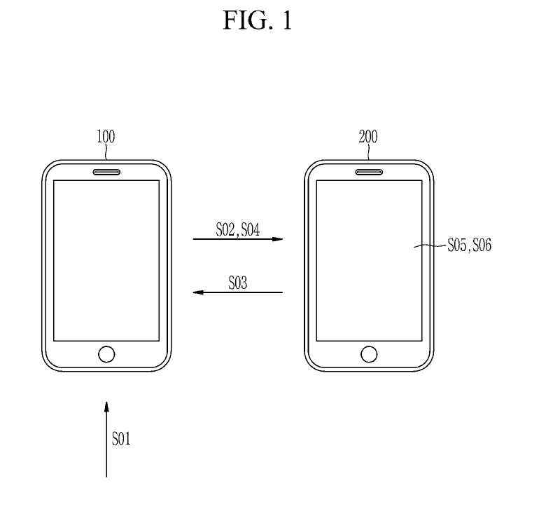

An outline of the present invention is described with reference to FIG. 1. FIG. 1 is a diagram for explaining an overview of a data sharing system 1 according to an embodiment of the present invention. The data sharing system 1 includes a transmitting terminal 100 and a counterpart terminal 200. The number of each device is not limited to one, but may be two or more. Further, each process described later may be executed by either or both of the above-described devices. In addition, each device may be realized by either an existing device or a virtual device, or both the existing device and the virtual device.

The transmitting terminal 100 is a terminal device operated by a user and is a terminal device capable of performing data communication with the counterpart terminal 200. The transmitting terminal 100 is, for example, an electric appliance such as a mobile phone, a portable information terminal, a personal computer, a netbook terminal, a slate terminal, an electronic book terminal, a portable music player, or the like.

The counterpart terminal 200 is a terminal device operated by a counterpart user and is a terminal device capable of data communication with the transmitting terminal 100. The counterpart terminal 200 is an electric appliance similar to the transmitting terminal 100.

First, the transmitting terminal 100 receives an input of a request from the user (step S01). The request is information for notifying the counterpart user of sick condition of the user or malfunction of an electric appliance owned by the user.

The transmitting terminal 100 specifies the counterpart terminal 200 to be a connection destination based on the received request, and notifies the specified counterpart terminal 200 of request data (step S02). The transmitting terminal 100 analyzes a keyword included in the request and notifies the request data to the counterpart terminal 200 associated with the keyword. The request data are an identifier of the transmitting terminal 100, a name of the user, the content of the request, or the like.

The counterpart terminal 200 transmits to the transmitting terminal 100 an information disclosure request about whether or not to disclose information related to the request to the counterpart user (step S03). The information related to the request is personal data such as physical information of the user, information of an electric appliance owned by the user, or the like which the transmitting terminal 100 stores in advance.

The transmitting terminal 100 arbitrarily selects information to be disclosed to the counterpart user from the information related to the request based on the received information disclosure request, and transmits disclosure status data indicating the selected information related to the request to the counterpart terminal 200 (step S04). The disclosure status data includes personal data related to the request and information indicating the disclosure status of the personal data.

The counterpart terminal 200 receives the disclosure status data, executes data sharing with the transmitting terminal 100, displays the personal data selected by the user on its own display unit based on the disclosure status data, and does not display the non-selected personal data (step S05). At this time, the transmitting terminal 100 also displays the data displayed by the counterpart terminal 200 as shared data. The counterpart terminal 200 may arbitrarily customize the personal data to be displayed on a graph, a table, or the like, and display them on the screen. As a method of the data sharing, for example, screen sharing, video call by P2P (peer-to-peer), video call through a server, video chat by a chat application or the like is given. The data sharing method may be other methods.

The counterpart terminal 200 stores the shared data displayed on the shared data excluding the personal data (step S06).

The above is the overview of the data sharing system 1.

System Configuration of Data Sharing System 1

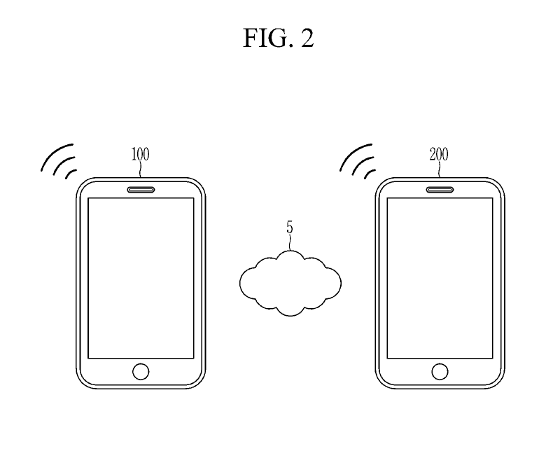

A system configuration of the data sharing system 1 according to an embodiment of the present invention is described with reference to FIG. 2. FIG. 2 is a diagram showing a system configuration of a data sharing system 1 according to an embodiment of the present invention. The data sharing system 1 includes a transmitting terminal 100, a counterpart terminal 200, and a public line network (Internet network, third or fourth generation communication network, or the like) 5.

Here, the transmitting terminal 100 and the counterpart terminal 200 may exist on the system by the number of users who execute data sharing and the number of counterpart users, respectively. In addition, each process described later may be executed by either of the transmitting terminal 100 or the counterpart terminal 200, or both the transmitting terminal 100 and the counterpart terminal 200. Further, the transmitting terminal 100 and the counterpart terminal 200 may be realized by virtual devices instead of existing devices. Furthermore, a server may exist in the data sharing system 1. In this case, the server may be configured to relay data communication between the transmitting terminal 100 and the counterpart terminal 200.

The transmitting terminal 100 and the counterpart terminal 200 are the above-described terminal devices having functions described below.

Description of Functions

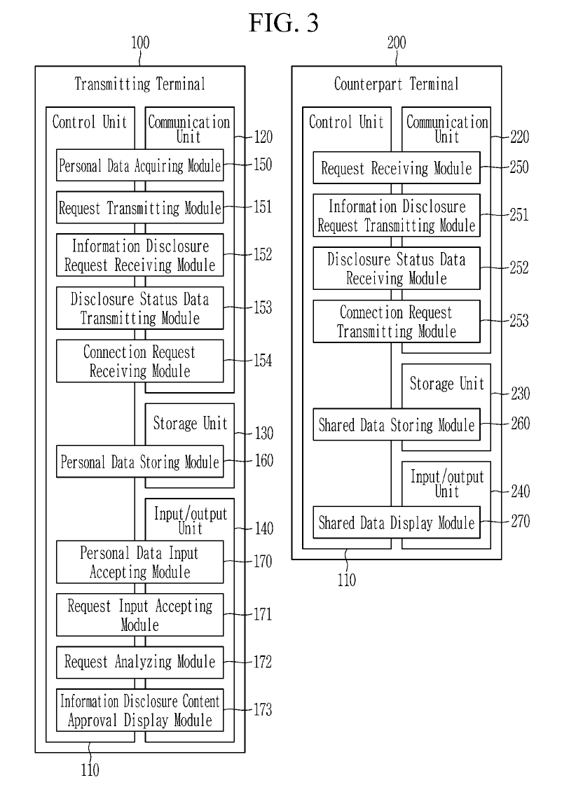

Functions of a transmitting terminal 100 and a counterpart terminal 200 according to an embodiment of the present invention are described with reference to FIG. 3. FIG. 3 is a functional block diagram of a transmitting terminal 100 and a counterpart terminal 200 according to an embodiment of the present invention.

The transmitting terminal 100 includes, as a control unit 110, a processor such as a CPU (Central Processing Unit), a RAM (Random Access Memory), a ROM (Read Only Memory), and the like, and includes, as a communication unit 120, a communication device for enabling communication with another device, for example, a WiFi (Wireless Fidelity) compatible device conforming to IEEE 802.11 or a wireless device conforming to the IMT-2000 standard such as the third or fourth generation mobile communication system. In addition, the transmitting terminal 100 includes, as a storage unit 130, a data storage device such as a hard disk, a semiconductor memory, a recording medium, a memory card, or the like. Further, the transmitting terminal 100 includes, as an input/output unit 140, a display device for outputting and displaying data or images controlled by the control unit 110, an input device, such as a touch panel, a keyboard, or a mouse, for accepting an input from the user.

In the transmitting terminal 100, the control unit 110 reads a predetermined program, thereby realizing, a personal data acquiring module 150, a request transmitting module 151, an information disclosure request receiving module 152, a disclosure status data transmitting module 153, and a connection request receiving module 154 in cooperation with the communication unit 120. Further, in the transmitting terminal 100, the control unit 110 reads a predetermined program, thereby realizing a personal data storing module 160 in cooperation with the storage unit 130. Furthermore, in the transmitting terminal 100, the control unit 110 reads a predetermined program, a personal data input accepting module 170, a request input accepting module 171, a request analyzing module 172, and an information disclosure content approval display module 173 in cooperation with the input/output unit 140.

Like the transmitting terminal 100, the counterpart terminal 200 includes, as a control unit 210, a processor such as a CPU, a RAM, a ROM, and the like, and includes, as a communication unit 220, a wireless device or the like for enabling communication with other devices. Further, the counterpart terminal 200 includes a data storage device as a storage unit 230, and includes, as an input/output unit 240, a display device, an input device, or the like.

In the counterpart terminal 200, the control unit 210 reads a predetermined program, thereby realizing a request receiving module 250, an information disclosure request transmitting module 251, a disclosure status data receiving module 252, a connection request transmitting module 253 in cooperation with the communication unit 220. Further, in the counterpart terminal 200, the control unit 210 reads a predetermined program, thereby realizing a shared data storing module 260 in cooperation with the storage unit 230. Furthermore, in the counterpart terminal 200, the control unit 210 reads a predetermined program, thereby realizing a shared data display module 270 in cooperation with the input/output unit 240.

Personal Data Registering Process

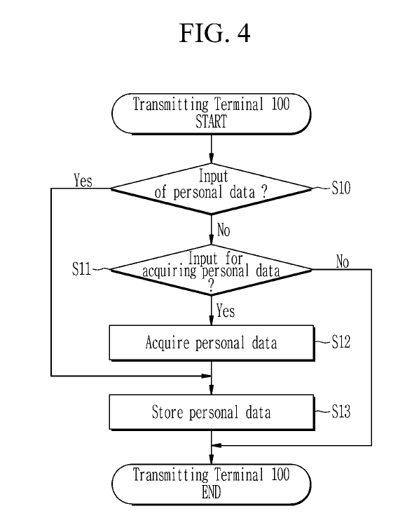

A personal data registering process executed by a transmitting side terminal 100 according to an embodiment of the present invention is described with reference to FIG. 4. FIG. 4 is a diagram showing a flowchart of personal data registering process executed by a transmitting terminal 100 according to an embodiment of the present invention. The processing executed by each module described above is described together with the present processing.

First, a personal data input accepting module 170 determines whether or not an input of personal data from a user is accepted (step S10). The personal data are, for example, physical information of the user or information on an electric appliance owned by the user. The physical information is information on health such as a height, a body weight, a body fat, a blood pressure, a blood glucose level, a previous meal content, or the like. Further, the information on the electric appliance is information on the electric appliance such as a purchase time, a manufacturer name, a model name, a manufacture number, a frequency of filter exchange, a frequency of cleaning, or the like. The personal data may be other information, for example, other information about a person, such as an asset of the user or an insurance to be subscribed, information on an items owned by the user, such as a vehicle or goods owned by the user, or other information.

In step S10, when the personal data input accepting module 170 determines that the input of personal data has not been accepted (NO in step S10), the personal data input accepting module 170 determines whether or not an input for acquire the personal data from an external device is accepted (step S11). In step S11, when it is determined that the input has not been accepted (NO in step S11), the personal data input accepting module 170 ends the present process.

On the other hand, in step S11, when the personal data input accepting module 170 determines that the input has been accepted (YES in step S11), the personal data acquiring module 150 acquires the personal data from the external device (step S12).

The external device transmits the personal data associated with the user to the transmitting terminal 100 based on various information such as the user's name or age, an identifier of the transmitting terminal 100, a manufacturing number of the transmitting terminal 100, a MAC address of the transmitting terminal 100, or the like, which is transmitted by the personal data acquiring module 150 so that the personal data acquiring module 150 acquires the personal data.

The personal data storing module 160 stores the acquired personal data as a personal data table (step S13). The transmitting terminal 100 may transmit the acquired personal data to an external device such as a server or another computer, and the external device may store the personal data table.

On the other hand, when it is determined that the personal data input accepting module 170 has accepted the input of personal data (YES in step S10), the personal data storing module 160 stores the input personal data as a personal data table (step S13). As described above, the transmitting terminal 100 may store the personal data in the external device.

Personal Data Table

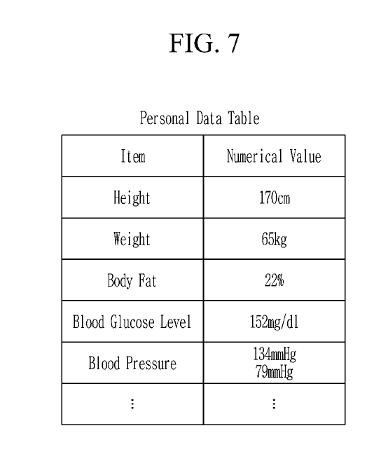

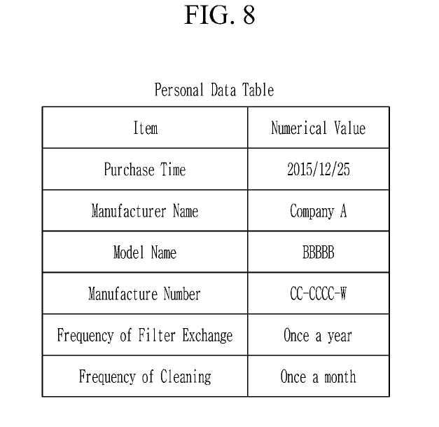

A personal data table is described with reference to FIG. 7 and FIG. 8. FIG. 7 shows a personal data table in a case of storing physical information as personal data. FIG. 8 shows a personal data table in a case of storing information on an electric appliance as personal data.

In FIG. 7, a personal data storing module 160 stores each item in personal data and a numerical value corresponding to each item as a personal data table. Each item in the personal data is a height, a weight, a body fat, a blood pressure, a blood glucose level, or the like. The numerical value is a value of each item.

In FIG. 8, the personal data storing module 160 stores each item in personal data and a numerical value corresponding to each item as a personal data table. Each item in the personal data is a purchase time, a manufacturer name, a model name, a manufacture number, a frequency of filter exchange, a frequency of cleaning, or the like. In addition, the numerical value is a value, a numeral or a character string of each item.

Types and the number of the items in the personal data table may be types and numbers other than the present embodiment. In addition to the items and the numerical values, other information such as a date and time when an input has been made, a user's name, or an identifier may be added to the table. Further, the numerical value is a value corresponding to the item, is not limited to a numeral or a character string, and may be a symbol or the like.

The above is the personal data registering process.

Each processing described above being executed by the transmitting terminal 100, but it may be executed by the counterpart terminal 200.

Request Transmitting Process

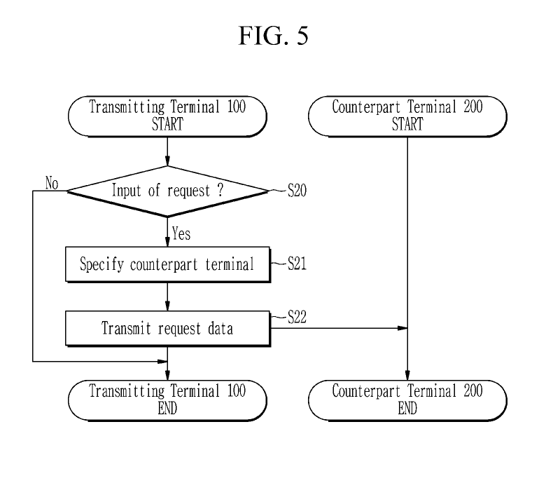

A request transmitting process executed by a transmitting terminal 100 and a counterpart terminal 200 according to an embodiment of the present invention is described with reference to FIG. 5. FIG. 5 is a diagram showing a flowchart of a request transmitting process executed by a transmitting terminal 100 and a counterpart terminal 200 according to an embodiment of the present invention. The processing executed by module of each device described above is described together with this processing.

A request input accepting module 171 determines whether or not an input of a request from the user is accepted (step S20). The request is, for example, information for notifying sick condition of a user's body to a counterpart user or information for notifying malfunction of an electric appliance owned by the user to the counterpart user. The counterpart user is, for example, a doctor or a manufacturing support. A specific example of the request is “the right side of the stomach hurts”, “the electric appliance does not work”, or the like. The request may be a request other than the example described above. Further, the counterpart user may be a user other than the example described above.

In step S20, when it is determined that the input of the request has not been accepted (NO in step S20), the request input accepting module 171 ends the present process. On the other hand, in step S20, when the request input accepting module 171 determines that the input of the request has been received (YES in step S20), a request analyzing module 172 determines a counterpart terminal 200 based on the accepted request (step S21). In step S21, the request analyzing module 172 extracts a keyword included in the accepted request and specifies the counterpart terminal 200 associated with this keyword. For example, when the request is “the right side of the stomach hurts”, the request analyzing module 172 extracts “stomach”, “right side” and “hurts” as keywords, and transmits a request to the counterpart terminal 200 which is most associated with the extracted keywords. In this case, the counterpart terminal 200 existing in the medical institution is specified as a connection destination, based on the keywords “stomach” and “hurts”. Further, when the request is “the electric appliance does not work”, the request analyzing module 172 extracts “electric appliance” and “not work” as keywords, and specifies the counterpart terminal 200 which is most associated with the extracted keywords. In this case, the counterpart terminal 200 existing in the manufacturing support is specified as the connection destination, based on the keyword “electric appliance”.

The request analyzing module 172 may specify the counterpart terminal 200 based only on a specific keyword, or may specify the counterpart terminal 200 associated with any or all of a plurality of keywords as the connection destination. In addition, the request analyzing module 172 may specify the counterpart terminal 200 as the connection destination by a method other than the keyword, for example, a method in which the request input accepting module 171 accepts an input of designating the counterpart terminal 200 to be the connection destination and the designated counterpart terminal 200 is specified as the connection destination. Alternatively, the counterpart terminal 200 may be specified by other methods.

The request transmitting module 151 transmits request data, which are information indicating the request, to the specified counterpart terminal 200 (step S22).

The request data include an identifier of the transmitting terminal 100, a name or an identification number of the user, the content of the request, or the like.

The request receiving module 250 receives the request data transmitted by the transmitting terminal 100.

When there is a server in the system, the transmitting terminal 100 may transmit the request to the server, and the server may analyze the request, identify the counterpart terminal 200 to be the connection destination, and transmit the request to the specified counterpart terminal 200.

The above is the request transmitting process. As such, according to some embodiments, because the counterpart terminal for the data sharing is specified in accordance with the keyword within request, information can be shared with a first counterpart terminal but cannot be shared with a second counterpart terminal based on the keyword included in the request. In other words, the information can be prevented from being shared or can be shared based on the keyword included in the request. Accordingly, information not intended by the user can be prevented from being shared with a certain counterpart terminal and information desired by the user can be shared with a certain counterpart terminal such that the convenience of the data sharing system can be improved.

Information Disclosing Process

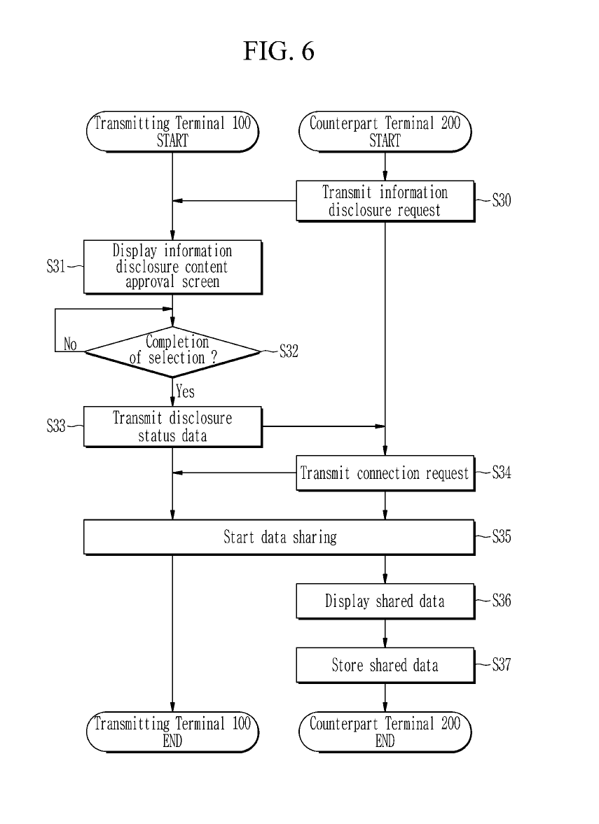

Next, an information disclosing process executed by a transmitting terminal 100 and a counterpart terminal 200 according to an embodiment of the present invention is described with reference to FIG. 6. FIG. 6 is a diagram showing a flowchart of an information disclosing process executed by a transmitting terminal 100 and a counterpart terminal 200 according to an embodiment of the present invention. The processing executed by module of each device described above is described together with this processing.

An information disclosure request transmitting module 251 transmits an information disclosure request, which is a request for approval as to whether or not personal data can be disclosed to a counterpart user, to a transmitting terminal 100 (step S30). The disclosure request is a request for approval as to whether or not the personal data which are information related to the request can be disclosed to the counterpart terminal 200.

If there is a server in the system, the server may be configured to transmit the information disclosure request to the transmitting terminal 100.

An information disclosure request receiving module 152 receives the information disclosure request. An information disclosure content approval display module 173 displays an information disclosure content approval screen based on the received information disclosure request (step S31).

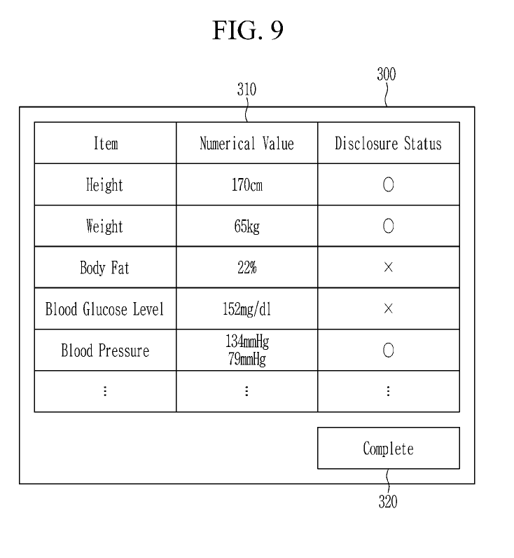

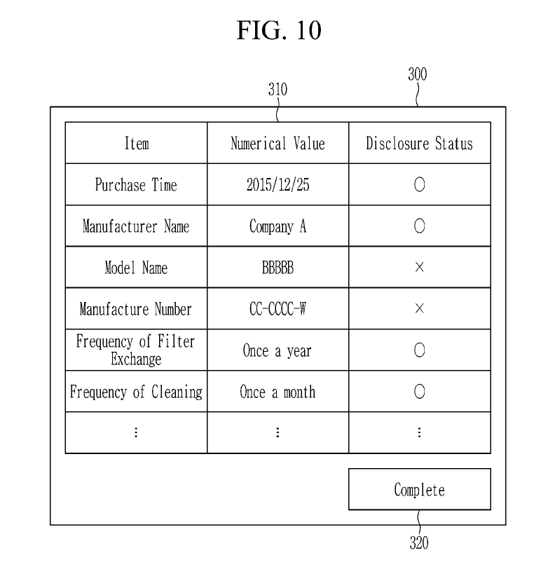

The information disclosure content approval screen displayed by the information disclosure content approval display module is described with reference to FIG. 9 and FIG. 10. FIG. 9 and FIG. 10 are diagrams showing an example of an information disclosure content approval screen displayed by an information disclosure content approval screen display module 173. FIG. 9 is a diagram showing an information disclosure content approval screen of physical information of a user as information related to the request. FIG. 10 is a diagram showing an information disclosure content approval screen of information on an electric appliance owned by as a user as information related to the request.

The information disclosure content approval display module 173 displays a disclosure status display screen 310 associated with each item of personal data, a numerical value of each item, and a disclosure status, and a completion icon 320, in an information disclosure content approval display area 300. Each item and the numerical value of the personal data are the same as the above-described configuration. The disclosure status is a field for selecting and specifying items to be disclosed to the counterpart terminal 200 by the user. The information disclosure content approval display module 173 accepts a selection input from the user and designates which item is to be disclosed to the counterpart terminal 200. The information disclosure content approval display module 173 displays “O” in the column of the disclosure status of the item which is designated as information to be disclosed to the counterpart terminal 200 by the user. In addition, the information disclosure content display module 173 displays “X” in the column of the disclosure status of the item which is designated as the information not to be disclosed to the counterpart terminal 200 by the user, or the item which is not designated by the user. Further, the information disclosure content approval display module 173 determines that the designation of personal data to be disclosed to the counterpart terminal 200 is completed by accepting an input to the completion icon 320 from the user. The display content in the disclosure status column is not limited to the content of the present embodiment. For example, the information disclosure content display module 173 may display “YES” in the disclosure status column of the information to be disclosed and “NO” in the information disclosure column of the information not to be disclosed. Further, a check box may be displayed in the disclosure status column, a check mark or information indicating checking may be displayed in the disclosure status column of the information to be disclosed, and the disclosure status column of the information not to be disclosed may be left blank. Furthermore, these display contents may be appropriately combined or other display contents may be used.

The information disclosure content approval display module 173 determines whether or not the selection is completed (step S32). In step S32, the information disclosure content approval display module 173 determines whether or not the selection is completed based on whether or not an operation of the completion icon 320 is accepted. In step S32, when the information disclosure content approval display module 173 determines that the selection is not completed (NO in step S32), that is, when the information disclosure content approval display module 173 determines that the operation of the completion icon 320 is not accepted, this process is repeated until the operation is accepted.

On the other hand, when the information disclosure content approval display module 173 determines that selection is completed (YES in step S32), that is, when determines that operation of the completion icon 320 is accepted, the disclosure status data transmission module 153 transmits disclosure status data to the counterpart terminal 200 (step S33). The disclosure status data include information of the items, the numerical values and the disclosure statuses of personal data described above.

A disclosure status data receiving module 252 receives the disclosure status data. A connection request transmitting module 253 transmits a connection request for establishing a connection related to data sharing to the transmitting terminal 100 (step S34).

When there is a server in the system, the transmitting terminal 100 may transmit the disclosure status data to the server, and the server may transmit the disclosure status data to the counterpart terminal 200, or transmit only the personal data designated to be disclosed to the counterpart terminal based on the disclosure status data.

A connection request receiving module 154 receives the connection request. The transmitting terminal 100 and the counterpart terminal 200 start data sharing (step S35).

The establishment of the connection related to the data sharing between the counterpart terminal 200 and the transmitting terminal 100 is not limited to the above-described timing, and may be executed at other timings. For example, the connection related to the data sharing may be established at the timing at which the transmitting terminal 100 transmits the request, or may be established at other timings.

If there is a server in the system, the connection request for establishing the connection related to the data sharing may be transmitted to each of the transmitting terminal 100 and the counterpart terminal 200 so that the connection related to the data sharing is established.

A shared data display module 270 displays shared data (step S36). In step S36, the transmitting terminal 100 displays the data which are shared with the counterpart terminal 200 as the shared data.

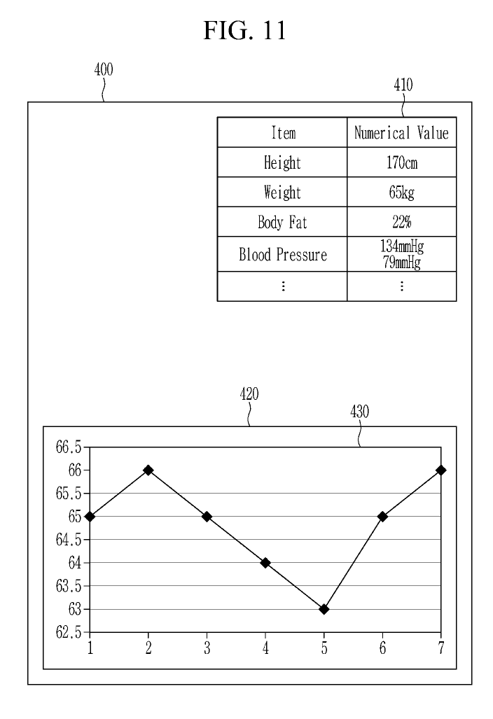

FIG. 11 is a diagram showing shared data in physical information of a user displayed by a shared data display module 270. In FIG. 11, the shared data display module 270 displays a personal data display area 410 and a customized data display area 420 as shared data 400. Each of the transmitting terminal 100 and the counterpart terminal 200 displays data to be displayed on the shared data 400. Personal data based on the received disclosure status data are displayed in the personal data display area 410. That is, in the personal data display area 410, only the personal data which are approved to be disclosed to the counterpart user in accordance with the disclosure status data are displayed, and personal data which are not approved to be disclosed to the counterpart user based on the disclosure status data are not displayed. In FIG. 11, the shared data display module 270 displays a height, a weight, a body fat, a blood pressure, or the like as personal data. In the customized data display area 420, customized data 430 obtained by arbitrarily customizing the personal data based on the received disclosure status data are displayed. That is, in the customized data display area 420, the customized data 430 which are obtained by arbitrarily customizing the personal data approved to be disclosed to the counterpart user in accordance with the disclosure status data are displayed. In FIG. 11, the shared data display module 270 displays the customized data 430 showing information on the weight as a graph. The shared data display module 270 acquires a plurality of pieces of information on the weights of the same user, customizes the data on a time series basis based on inputted dates and times, and displays the customized data 430 in the form of the graph. The customized data to be displayed in the customized data display area 420 is not limited to the present embodiment, but may be customized data obtained by customizing other items. The display content thereof is not limited to the graph, but may be arbitrarily customized to other contents. In addition, the number of customized data displayed in the customized data display area 420 is not limited to one, but may be two or more, or may not be displayed. The content of the customization is not limited to one item, but may be customized data obtained by combining and customizing a plurality of items, or may be appropriately changed to other aspects. Further, the content of the customization may be appropriately changed based on an input from the counterpart user or the user. Furthermore, the content of customization may be displayed in a preset manner

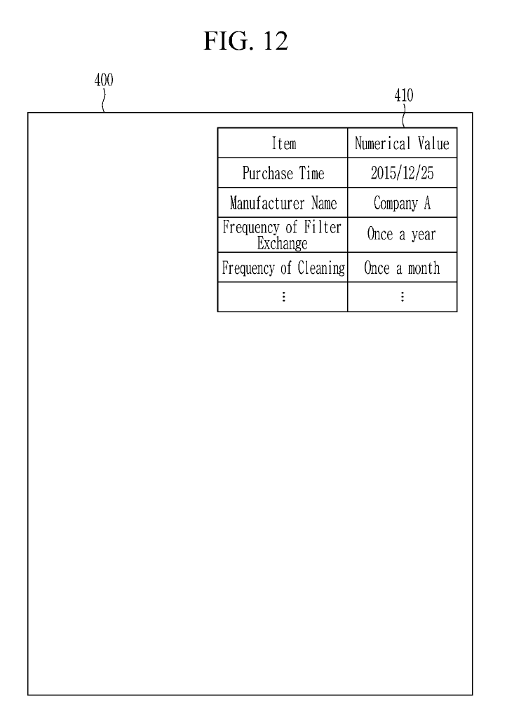

FIG. 12 is a diagram showing shared data in information on an electric appliance owned by a user displayed by a shared data display module 270. In FIG. 12, the same reference numerals are given to the same elements as those in FIG. 11 described above, and a detailed description thereof is omitted. In FIG. 12, the shared data display module 270 displays a personal data display area 410 as shared data 400. Each the transmitting terminal 100 and the counterpart terminal 200 displays data to be displayed on the shared data 400. In FIG. 12, the shared data display module 270 displays, as personal data, a purchase time, a manufacturer name, a frequency of filter exchange, a frequency of cleaning, and the like, which are items selected by the user. While the shared data display module 270 does not display a customized data display area 420 in FIG. 12, the shared data display module 270 may display the customized data display area 420 in the same manner as in FIG. 11.

A shared data storing module 260 stores the displayed shared data (step S37). The shared data storing module 260 stores information of data excluding the personal data displayed in the shared data, as shared data. The personal data are deleted without being stored.

When there is a server in the system, the counterpart terminal 200 may transmit the shared data excluding the personal data displayed in the shared data to the server, and the server may store the shared data. In addition, the counterpart terminal 200 may transmit the shared data and the personal data to the server, and the server may delete the personal data and store only the shared data.

The above is the information disclosing process. As such, according to some embodiments, because the information related to the request is transmitted to the counterpart terminal when the transmitting terminal approves to disclose the information related to the request to the counterpart terminal, information not intended by the user can be prevented from being shared and information desired by the user can be shared. Accordingly, information not intended by the user can be from being shared with the counterpart terminal and information desired by the user can be shared with the counterpart terminal such that the convenience of the data sharing system can be improved.

The means and functions described above are realized by reading and executing a predetermined program by a computer (including a CPU, an information processing device, or various terminals). The program is provided, for example, in a form recorded in a computer-readable recording medium such as a flexible disk, a CD (e.g., CD-ROM or the like), a DVD (DVD-ROM, DVD-RAM, or the like), or the like. In this case, the computer reads the program from the recording medium and transfers the program to an internal storage unit or an external storage unit so as to be stored and executed. Furthermore, the program may be, for example, recorded in a storage device (recording medium) such as a magnetic disk, an optical disk, an optical magnetic disk, or the like in advance and be provided from the recording medium to the computer via communication line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### DESCRIPTION OF REFERENCE NUMBERS

1: data sharing system, 100: transmitting terminal, 200: counterpart terminal

What is claimed is:

1. A data sharing system of performing data sharing by transmitting data stored in a transmitting terminal operated by a user to a counterpart terminal operated by a counterpart user, comprising:
a request accepting unit that accepts a request including a keyword from the transmitting terminal;
an analyzing unit that extracts a keyword within the request and specifies a counterpart terminal corresponding to the request in accordance with the keyword;
a request notifying unit that notifies the request to the counterpart terminal;
an approval unit that requests to the transmitting terminal an approval about whether to disclose information related to the request to the counterpart terminal; and
an information sharing unit that transmits the information related to the request to the counterpart terminal to perform data sharing when the approval is made.

2. The data sharing system according to claim 1, wherein the approval unit allows the user to arbitrarily select information to be disclosed to the counterpart user from among a plurality of information related to the request, and
wherein the information sharing unit transmits only the information selected by the approval unit to the counterpart terminal to perform the data sharing.

3. The data sharing system according to claim 1, wherein the analyzing unit extracts a plurality of keywords within the request and specifies the counterpart terminal corresponding to all of the plurality of keywords.

4. The data sharing system according to claim 1, further comprising a storing unit that stores data excluding the information related the request.

5. A data sharing method for performing data sharing by transmitting data stored in a transmitting terminal operated by a user to a counterpart terminal operated by a counterpart user, comprising:
accepting a request including a keyword from the transmitting terminal;
extracting a keyword within the request and specifying a counterpart terminal corresponding to the request in accordance with the keyword;
notifying the request to the counterpart terminal;
requesting to the transmitting terminal an approval about whether to disclose information related to the request to the counterpart terminal; and
transmitting the information related to the request to the counterpart terminal to perform data sharing when the approval is made.

6. A program for causing a data sharing system of performing data sharing by transmitting data stored in a transmitting terminal operated by a user to a counterpart terminal operated by a counterpart user to execute:
accepting a request including a keyword from the transmitting terminal;
extracting a keyword within the request and specifying a counterpart terminal corresponding to the request in accordance with the keyword;
notifying the request to the counterpart terminal;
requesting to the transmitting terminal an approval about whether to disclose information related to the request to the counterpart terminal; and
transmitting the information related to the request to the counterpart terminal to perform data sharing when the approval is made.
